(19) United States
(12) Patent Application Publication
(10) Pub. No.: US 2008/0209295 A1
(43) Pub. Date: Aug. 28, 2008

(54) APPARATUS AND METHOD FOR PRE-PROCESSING ON LAYER 2 IN DIGITAL BROADCASTING RECEIVING DEVICE

(76) Inventor: Dong-jo Kim, Suwon-si (KR)

Correspondence Address: F. CHAU & ASSOCIATES, LLC, 130 WOODBURY ROAD, WOODBURY, NY, 11797, US

(21) Appl. No.: 12/033,530

(22) Filed: Feb. 19, 2008

(30) Foreign Application Priority Data
Feb. 26, 2007 (KR) 10-2007-0019131

(51) Int. Cl. G06F 11/00

(52) U.S. Cl. 714/746

(57) ABSTRACT

A method of correcting an error in a transport stream (TS), and a digital broadcasting receiving method are provided. The TS is transmitted from a physical layer. It is determined whether a pointer included in the TS has an error. The pointer is corrected if it is determined that the pointer has an error. It is determined whether a frame buffer value is correct. The frame buffer value is corrected if it is determined that the frame buffer value is not correct. In the TS error correcting method, a pointer error or an erroneous frame buffer value existing in a TS is corrected before the TS is transmitted to an upper layer (e.g., a link layer), and IP data can be transmitted to the upper layer. Accordingly, performance degradation due to Doppler shift can be addressed.

### CROSS-REFERENCE TO RELATED APPLICATION

This application claims priority to Korean Patent Application No. 10-2007-0019131, filed on Feb. 26, 2007, in the Korean Intellectual Property Office, the disclosure of which is herein incorporated by reference in its entirety.

### BACKGROUND OF THE INVENTION

1. Technical Field

The present invention relates to pre-processing, and more particularly, to an apparatus and method for pre-processing on layer 2 in a digital broadcasting receiving device.

2. Discussion of the Related Art

A moving picture experts group (MPEG) has been established to facilitate the transmission, reception and storage of multi-media data. A variety of multi-media broadcasting systems including digital video broadcasting-handheld (DVB-H) transmit and receive data according to MPEG standards.

In DVB-H or a broadcasting system similar thereto, a frequency variation known as a Doppler shift occurs when the receiving station is mobile, for example, when reception occurs within a moving vehicle. A sufficiently large Doppler shift may result in the generation of an error within the transport stream (TS) that is transmitted from a physical layer to an upper layer (e.g., a link layer or layer 2). When errors are generated in packet identifier (PID) areas of TSs, the TSs may fail to transmit.

In this case, burst errors are generated. Burst errors are errors that are consecutively generated in a plurality of TSs. When this occurs, TSs cannot be properly located in a frame memory at a link layer. Finally, data is unable to be corrected even by multi protocol encapsulation-forward error correcting (MPE-FEC). This results in a degradation of the performance of a receiving device. MPE-FEC denotes a correction of errors generated in MPE data, and examples of the MPE-FEC may include an operation of overwriting original TSs.

Conventional receiving devices do not correct errors generated in TSs, before performing MPE-FEC. Therefore, as described above, when data is received while moving, previously destroyed TSs cannot be recovered although MPE_FEC is performed thereon. Thus, conventional receiving devices are unable to recover data transmitted while moving, and an erroneous image or a broken image may be displayed.

### SUMMARY OF THE INVENTION

Exemplary embodiments of the present invention provide methods of correcting an error in a transport stream (TS), in which the error in the TS is corrected before transmission of IP data to an upper layer to receive exact data even when moving.

Exemplary embodiments of the present invention also provide a digital broadcasting receiving device capable of receiving exact data even when moving by correcting an error in a TS before transmission of IP data to an upper layer.

According to an aspect of the present invention, there is provided a method of correcting an error in a transport stream, including the operations of transmitting the transport stream from a physical layer, determining whether a pointer included in the transport stream has an error, correcting the pointer if it is determined that the pointer has an error, and determining whether a frame buffer value is correct and correcting the frame buffer value if it is determined that the frame buffer value is not correct.

The frame buffer value may indicate a location on a frame memory where image data of an MPE section included in the transport stream is to be placed, and may be obtained by decoding a header of the MPE section.

The operation of determining whether the pointer has an error may include the operation of determining whether an error exists in an error indicator included in a header of the transport stream.

The operation of determining whether the pointer has an error may further include the operation of determining whether an error exists in the data of the pointer.

The determination as to whether an error exists in the data of the pointer may be made by determining whether the counter has continuity.

The operation of correcting the frame buffer value may include the operations of determining whether a lost transport stream exists, determining whether the frame buffer value is correct, according to existence or nonexistence of the lost transport stream, and correcting and outputting the frame buffer value.

According to another aspect of the present invention, there is provided a digital broadcasting receiving device including a radio frequency tuner, a demodulator, a preprocessor, and an IP filter.

The radio frequency tuner receives a radio frequency signal, tunes the received radio frequency signal, transforms the radio frequency signal into a baseband frequency signal, and transmits the baseband frequency signal.

The demodulator receives the baseband frequency signal and restores the baseband frequency signal to a frequency signal originally transmitted from a broadcasting station to output a transport stream signal.

The preprocessor determines whether an error exists in a pointer included in the transport stream, corrects the error, determines whether a frame buffer value is correct, and corrects and outputs the frame buffer value.

The IP filter receives an output signal of the preprocessor, filters the output signal and outputs IP data.

The frame buffer value may be address information indicating a location on a frame memory where image data of an MPE section included in the transport stream is to be placed, and may be obtained by decoding a header of the MPE section.

The preprocessor may determine whether the pointer has an error, by determining whether an error exists in an error indicator included in a header of the transport stream or whether an error exists in the data of the pointer.

The preprocessor may determine whether an error exists in the counter of the transport stream, determine how much of the transport stream has been lost if it is determined that an error exists in the counter of the transport stream, and correct the frame buffer value according to a result of the determination of how much of the transport stream has been lost.

### BRIEF DESCRIPTION OF THE DRAWINGS

The above and other features and aspects of the exemplary embodiments of the present invention will be described in detail with reference to the attached drawings in which:

FIG. 1A illustrates a transport stream (TS) and Internet protocol (IP) data;

FIG. 1B illustrates the TS of FIG. 1A in greater detail;

FIG. 2 illustrates a frame memory on which payload data included in a TS is located;

FIG. 3A is a flowchart of a method of correcting errors in TSs, according to an embodiment of the present invention;

FIG. 3B is a flowchart illustrating the error correcting method of FIG. 3A in greater detail;

FIG. 4 is a block diagram of a digital broadcasting receiving device according to an embodiment of the present invention;

FIG. 5A illustrates original data transmitted to a digital broadcasting receiving device;

FIG. 5B illustrates data having a TS error in a conventional digital broadcasting receiving device;

FIG. 5C illustrates data TS-error-corrected and received in the digital broadcasting receiving device illustrated in FIG. 4; and

FIG. 6 is a graph showing a relationship between a frequency variation caused by a Doppler effect and a burst error rate in a conventional receiving device according to an exemplary embodiment of the present invention.

### DETAILED DESCRIPTION OF THE EXEMPLARY EMBODIMENTS

Hereinafter, exemplary embodiments of the present invention will be described in detail with reference to the attached drawings. Like reference numerals in the drawings may denote like elements.

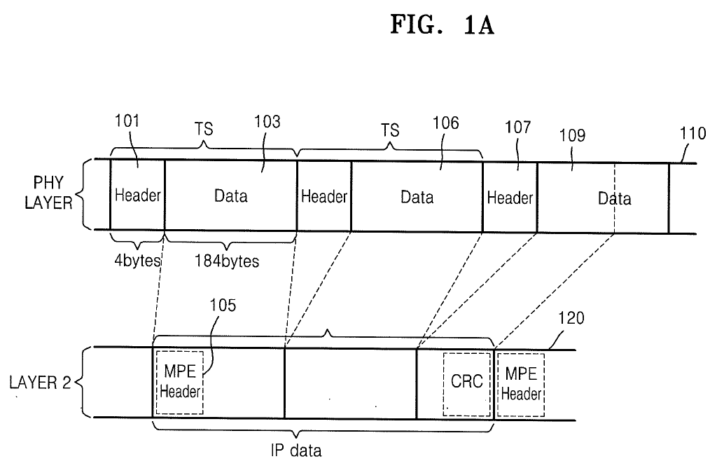

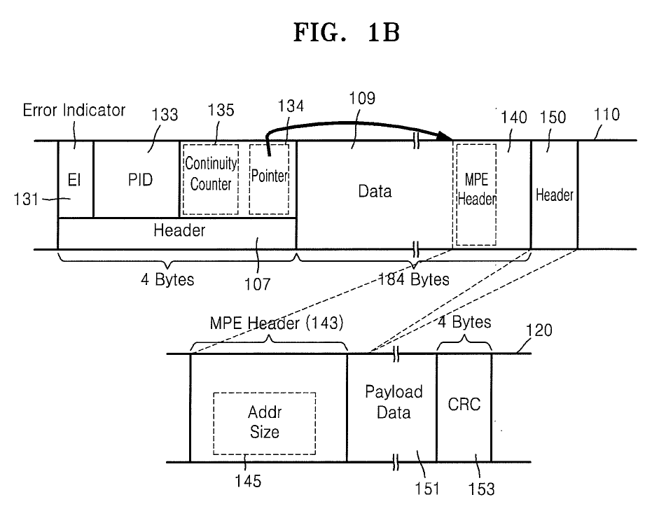

FIG. 1A illustrates a transport stream (TS) and Internet protocol (IP) data. Referring to FIG. 1A, image data received from a radio frequency (RF) tuner, for example, is transmitted in the form of a TS 110 at a physical layer.

Each TS 110 is divided into a header 101 and a data area 103. The header 101 includes a variety of information (e.g., channel information, generation or non-generation of errors, etc.) to decode the TS 110. The data area 103 includes audio & video data to be displayed and information about a location on a frame memory where, for example, the audio & video data is to be placed.

The data areas 103, 106, and 109 of the TSs 110 are re-transmitted to an upper layer. Here, the upper layer is a link layer or Layer 2 120. Several data areas, for example, the data areas 103, 106, and 109, are transmitted to Layer 2 120 and are combined with one another. As such, each data area transmitted to an upper layer is referred to as IP data. A single multi protocol encapsulation (MPE) section is a sum of several IP data. The last data incorporated into the MPE section is a part of the data area 109. Other parts of the data may be incorporated into the MPE section in a next MPE section.

While the data 103 of the TS 110 is being transmitted to the upper layer, a header 105 of an MPE section is generated.

FIG. 1B illustrates the TS 110 of FIG. 1A in greater detail. Referring to FIG. 1B, the TS 110 is divided into a TS header 107 and a TS data area 109.

The TS header 107 includes an error indicator (EI) 131, a packet identifier (PID) 133, a continuity counter 135, and a pointer 134. The EI 131 includes information about whether an error has occurred in the TS header 107. The PID 133 includes information about a channel. Different PIDs 133 exist for different broadcasting channels. Therefore, consecutive TSs may have identical PIDs 133.

The continuity counter 135 includes information about the continuity of consecutive TSs. When a counter of an n-th TS is 0001, a counter of an (n+1)th TS is 0010.

The pointer 134 indicates a location (for example, an offset) on the TS data area 109 from which a new MPE section starts. For example, when data of the pointer 134 represents 0×7, first through seventh bytes of the TS data area 109 constitute a previous MPE section and a new MPE section starts from an eighth byte thereof.

The TS data area 109 may constitute a part or the whole of an MPE section 140. In general, the size of an MPE section 140 is greater than the size (e.g., 188 bytes) of a TS, and the MPE section 140 is distributed to several TSs and transmitted from the physical layer. The MPE section 140 includes an MPE header 143, payload data 151, and a cyclic redundancy check (CRC) 153. The MPE header 143 includes information about the size and address 145 of data of a corresponding MPE section to be located on a frame. The payload data 151, which is IP data, has image information to be displayed. The payload data 151 includes a header 150. The CRC 153 indicates an end of the corresponding MPE section.

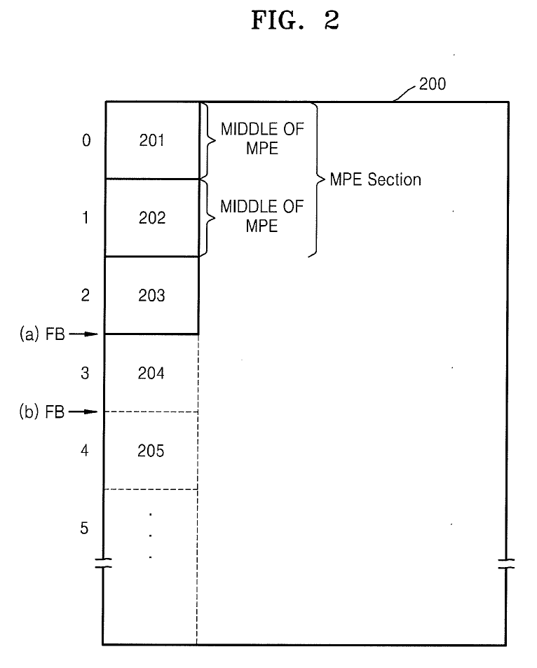

FIG. 2 illustrates a frame memory 200 on which payload data included in a TS is located.

Referring to FIG. 2, data (for example, an MPE section) excluding the TS header 107 of each TS 110 transmitted from a physical layer is transmitted onto the frame memory 200. The payload data 151, which is image data of the MPE section, is stored on the frame memory 200. The MPE section is received by the frame memory 200, and the payload data 151, excluding the MPE header 143 and the CRC 153, is stored in the frame memory 200.

A frame buffer (FB) denotes information representing an address on the frame memory 200 at which image data (for example, payload data) included in an MPE section is to be located. The FB is obtained by decoding an MPE header of the MPE section, and thus has the same value (for example, a meaning) as an address value existing in the MPE header. The FB indicates a location where first MPE data included in each TS is to be placed, and thus is used when generating MPE data for each TS and writing the MPE data to a memory. Therefore, when the value of the FB is properly kept for each TS, an image can be properly displayed.

When a TS 204 has been transmitted, the value of the FB is 3, indicating location (a). The counters of TSs 201, 202, 203, 204, and 205 have consecutive values.

When the counters of the TSs 203 and 204 have consecutive values, for example, 0010 and 0011, if the FB of the TS 204 indicates location (b) instead of location (a), the FB of the TS 204 has a wrong value. On the other hand, when the counters of the TSs 203 and 204 do not have consecutive values, for example, errors are generated in the counters, even if the FB of the TS 204 indicates location (a), the FB of the TS 204 still has a wrong value.

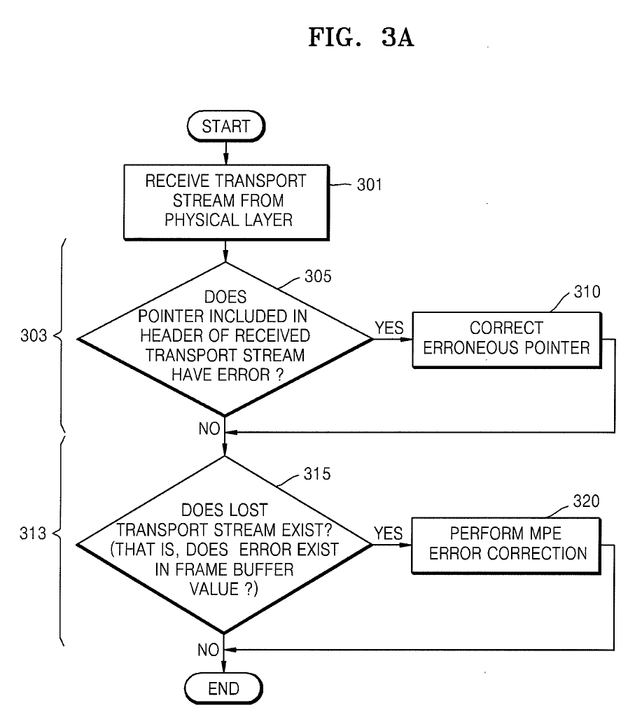

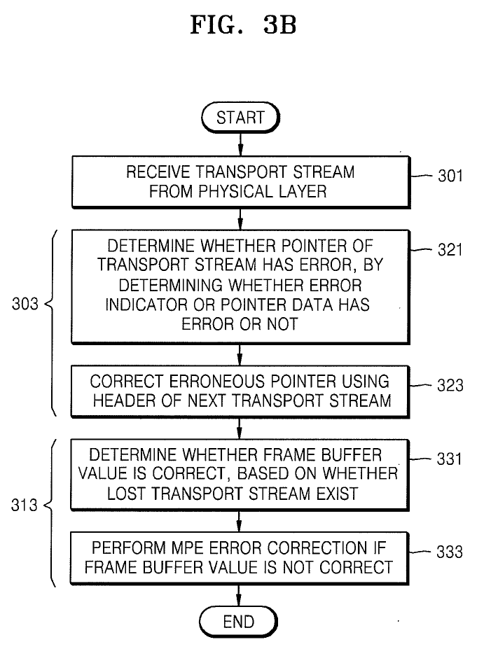

FIG. 3A is a flowchart of a method of correcting errors in TSs, according to an embodiment of the present invention.

FIG. 3B is a flowchart illustrating the error correcting method of FIG. 3A in greater detail.

Referring to FIGS. 3A and 3B, in a method of correcting errors in TSs according to an embodiment of the present invention, first, a TS is received from a physical layer in operation 301.

In operation 305, it is determined whether a pointer included in the header of the received TS has an error. The determination is made by determining whether an EI of the header has an error, whether the pointer indicates a wrong end of a data area of the received TS due to an error in the data of the pointer, and whether the MPE header of the next TS erroneously starts.

Generation of an error in a pointer of a TS occurs in the following cases. When an EI of the TS has a value of 1, indicating an activated state and that an error has been generated in the bites of the TS, the pointer also may have erroneous bits. When the EI has a value of 1, although no errors have been generated in the TS, the EI itself has an error. When information about a start of an MPE header of an MPE section has an error, although a data area of a TS is cut at a place indicated by the pointer and a new MPE section properly starts, it should be determined whether the pointer rightly indicates the cutting place.

Accordingly, referring to FIG. 3B, a determination as to whether the pointer of the TS has an error is made by determining whether the EI or the pointer data has an error, in operation 321. The determination as to whether the pointer of the TS has an error is made by using a counter or MPE header of a next TS. When the pointer of the TS indicates a tenth byte as a location on the data area of the TS that is to be cut, if the counter of a next TS is inconsecutive to the counter of the corresponding TS, the pointer erroneously indicates the location on the data area of the TS that is to be cut.

For example, when a TS in which an error has been generated due to the value ‘1’ of an EI is received and a pointer of the TS indicates a byte value less than or equal to 184, if the length of actually transmitted data is greater than 184 bytes, the pointer has an error. When information about the location of a next MPE section is decoded using information about the address and size of the MPE header, a location where the data area of the TS is to be cut can be predicted.

When it is determined that an error has been generated in the pointer, the erroneous pointer is corrected, in operation 310. In operation 323 of FIG. 3B, as described above, an exact pointer value is detected by decoding the header of the TS or the MPE header. The value of the erroneous pointer is corrected to the detected pointer value. Together, operations 305 and 310 of FIG. 3A and operations 321 and 323 of FIG. 3B form a group 303.

In operation 315, it is determined whether a lost TS exists. In operation 331 of FIG. 3B, a determination as to whether a FB value is correct is determined based on the result of the determination performed in operation 315.

The determination as to whether a FB value is correct is made according to existence or non-existence of a lost TS, because if the FB value indicates a location on a frame memory where to put a lost TS although the lost TS exists, wrong data is displayed.

The existence or non-existence of a lost TS is determined according to the continuity of the counter of the next TS. Referring to FIG. 2, when an FB indicates location (a) without detecting a loss of the TS 204 although the TS 204 is lost and the TS 205 is received, the TS 205 is located on a wrong place on the frame memory. In this case, the counters of the TSs 203 and 205 are inconsecutive. Accordingly, determinations as to whether a lost counter exists and accordingly whether an FB value is correct are made according to the continuity or discontinuity of the counter of the next TS.

In operation 320, if the FB value is not correct, MPE error correction is performed (operation 333). Together, operations 315 and 320 of FIG. 3A and operations 331 and 333 of FIG. 3B form a group 313.

Since an FB value is obtained by decoding the address & size information included in an MPE header, the value of the MPE header may be corrected to obtain a correct FB value. As described above, the FB value is updated in consideration of the number of lost counters.

If a pointer is included in a next MPE section, a value obtained by subtracting the size of a TS header from the erroneous FB value may be used as the FB value. The FB value should be updated in consideration of the data other than TS headers, MPE headers, and CRCs of lost TSs, because image data of an MPE section excluding a TS header may be located on the frame memory 200.

For example, it may be assumed that one TS has a size of 188 bytes, three TSs are lost, a TS header is made up of 4 bytes, an MPE head is made up of 12 bytes, and a CRC is made up of 4 bytes. Then, the capacity of a frame memory to be emptied in consideration of the lost TSs is 536 bytes (={(188−4)*3}−12−4). Accordingly, an FB value in which the lost TSs have not been reflected should be updated to the address of a location moved by as much as 536 bytes.

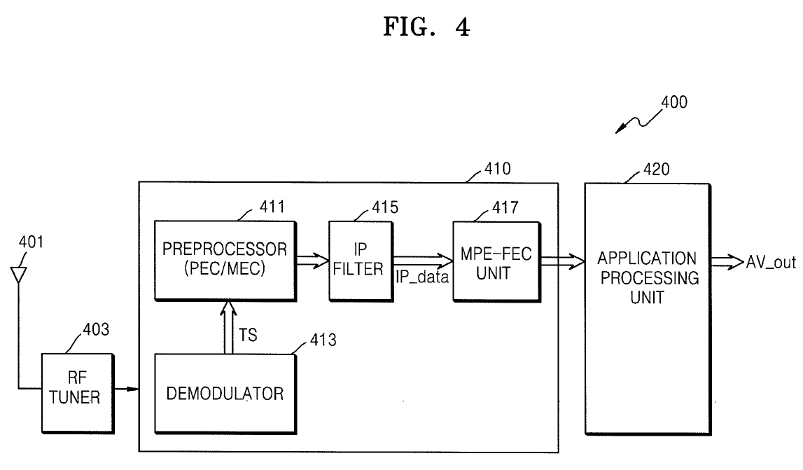

FIG. 4 is a block diagram of a digital broadcasting receiving device 400 according to an embodiment of the present invention. Referring to FIG. 4, the digital broadcasting receiving device 400 includes a radio frequency (RF) tuner 403. The receiver device also includes a preprocessor 411, an IP filter 415, an MPE-FEC unit 417, and a demodulator 413 (together 410). The digital broadcasting receiving device 400 may further include an application processing unit 420.

The RF tuner 403 receives an RF signal, tunes the received RF signal, transforms the RF signal into an intermediate frequency signal, and outputs the baseband frequency signal. Signals transmitted from a broadcasting station or a base station are RF signals. However, signals to be processed by a receiving device are baseband frequency signals. Accordingly, the RF tuner 403 is used to transform a received RF signal into a baseband frequency signal.

The demodulator 413 receives the baseband frequency signal and restores the baseband frequency signal to data of the same format as data transmitted from a broadcasting station (or a base station) to output a TS signal. The demodulator 413 serves as a physical layer and performs filtering to output only the TS signal.

The preprocessor 411 performs pointer error correction (PEC) and MPE error correction (MEC). The error correction performed in the preprocessor 411 may be similar to the TS error correcting method illustrated in FIGS. 3A and 3B.

The IP filter 415 receives an output signal of the preprocessor 411 and filters the output signal to output IP data. The IP filter 415 filters out a TS Header, an MPE header, and a CRC to create IP data that is to be transmitted to an upper layer (for example, Layer 2), and output IP data that is formed of image data of an MPE section.

The MPE-FEC unit 417 corrects errors generated in the IP data output by the IP filter 415 and outputs errors-corrected IP data to the application processing unit 420.

The application processing unit 420 transforms the received IP data into an audio/video signal.

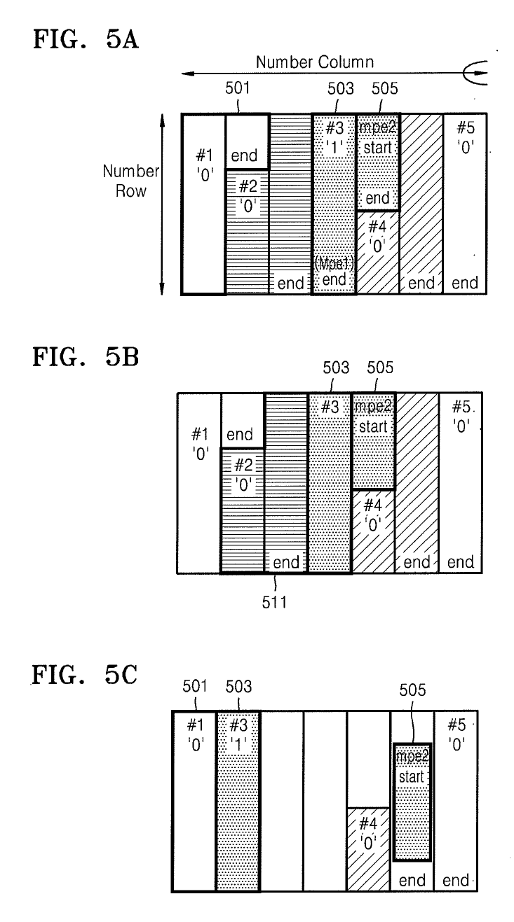

FIG. 5A illustrates original data transmitted to a digital broadcasting receiving device. Referring to FIG. 5A, #1 501, #2 503, #3 505 indicate TSs. Value ‘0° below reference character #1 indicates that an EI has a value of 0. Accordingly, the first TS #1 has no errors, and an errorless TS is transmitted to the receiving device.

The second TS #2 has an EI with a value of 0 and is accordingly errorless.

The third TS #3 has an EI with a value of ‘1’ and accordingly has an error, and thus an erroneous TS is transmitted to the receiving device.

FIG. 5B illustrates data having a TS error in a conventional digital broadcasting receiving device. Referring to FIG. 5B, the conventional digital broadcasting receiving device receives the data illustrated in FIG. 5A and locates the received data on a frame memory as illustrated in FIG. 5B.

In FIG. 5B, a case where the second TS #2 is lost while the data of FIG. 5A is being received in a conventional digital broadcasting receiving device is illustrated. An FB fails to detect a loss of the second TS #2 and thus locates a part 503 of the third TS #3 on the frame memory according to an FB value for the second TS #2. Therefore, the part 503 of the third TS #3 next to the lost TS #2 is erroneously located.

The third TS #3 has an EI with a value of 1, and thus an error where the remaining data (for example, mpe2) 505 of the third TS #3 is located in the middle of a fourth TS #4 is generated due to an error in information about the address of the MPE header.

As described above, in a reception environment of a mobile device, the probability of generating an error in received data is high, and consecutive errors are generated. As a result, even a properly received TS (for example, a TS #1) may not be properly displayed.

Due to the generation of consecutive errors, an error in the data of a TS may not be corrected even using a subsequent MPE-FEC process, and an erroneous image is displayed.

FIG. 5C illustrates data TS-error-corrected and received in the digital broadcasting receiving device 400 illustrated in FIG. 4.

Referring to FIG. 5C, the preprocessor 411 determines existence or nonexistence of lost TSs and corrects FB values according to the result of the determination. More specifically, if a second TS 511 is lost, the preprocessor 411 detects the loss of the second TS 511 and updates a FB value of the third TS 503 so that the FB value indicates a location where a third TS 503 comes in FIG. 5A. When lost data #2 exists, next data #3 is not affected by the loss of the data #2 by correcting information about the address and size of an MPE section. The area for the lost TS #2 is empty. During a subsequent MPE-FEC process, the MPE-FEC unit 417 can perform, for example, an operation of overwriting a new TS #2 on the empty area.

When an error is generated in a pointer of the third TS #3 and accordingly the pointer erroneously indicates a location on the frame memory from which the remaining data 505 starts, the error is corrected using a pointer error correcting process. In the pointer error correcting process, the pointer of the third TS. #3 is corrected so that a location within the remaining data 505 from which a new MPE header starts is a location indicated by the pointer of the third TS #3.

The MPE section correction and the pointer error correction are performed in the preprocessor 411 of the digital broadcasting receiving device 400 illustrated in FIG. 4.

As described above, before a TS is transmitted to Layer 2, an error generated in the TS is detected, and pre-processing for error correction is performed. Accordingly, even when a TS is lost or an error is generated in the TS, a TS received after a preprocessing operation according to embodiments of the present invention can be properly located. In addition, by performing a subsequent MPE-FEC operation, the TS error can be corrected.

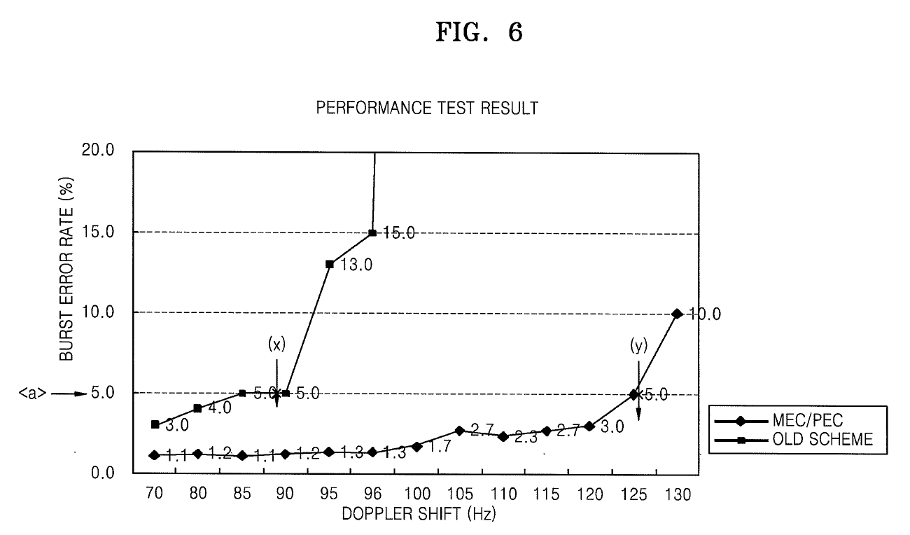

FIG. 6 is a graph showing a relationship between a frequency variation caused by a Doppler effect and a burst error rate in a conventional receiving device according to embodiments of the present invention.

Referring to FIG. 6, a burst error rate on the y axis indicates how many TSs have errors during reception of 100 TSs. When the burst error rate is less than or equal to 5%, TS reception is determined to be normal.

A conventional receiving device can perform normal reception only until point (x). A Doppler shift frequency at point (x) is about 90 Hz. A case where the Doppler shift frequency is 90 Hz corresponds to a case where a vehicle is moving at 150 km/h. Thus, normal reception may be impossible at or over 150 km/h, and an image fails to be properly displayed when received within a moving train.

A receiving device according to embodiments of the present invention can perform normal reception until point (y). A Doppler shift frequency at point (y) is about 125 Hz. A case where the Doppler shift frequency is 125 Hz corresponds to a case where a vehicle is moving at 200 km/h.

As described above, the receiving device according to embodiments of the present invention can increase the range of a Doppler shift frequency to over 30 Hz, and thus the reception performance depending on a Doppler shift can be increased.

As described above, in a TS error correcting method according to an aspect of the present invention, a pointer error or an erroneous frame buffer value existing in a TS is corrected before the TS is transmitted to an upper layer (e.g., a link layer), so that IP data can be transmitted to the upper layer. Accordingly, a performance degradation due to the Doppler shift can be addressed.

As described above, a digital broadcasting receiving device according to another aspect of the present invention corrects a pointer error or an erroneous frame buffer value existing in a TS before the TS is transmitted to an upper layer (e.g., a link layer), so that IP data can be transmitted to the upper layer. Accordingly, a performance degradation due to the Doppler shift can be addressed.

While embodiments of the present invention have been particularly shown and described with reference to the figures, it will be understood by those of ordinary skill in the art that various changes in form and details may be made therein without departing from the spirit and scope of the present invention.

What is claimed is:

1. A method of correcting an error in a transport stream, comprising:
transmitting the transport stream from a physical layer;
determining whether a pointer included in the transport stream has an error;
correcting the pointer when it is determined that the pointer has an error;
determining whether a frame buffer value is correct; and
correcting the frame buffer value when it is determined that the frame buffer value is not correct.

2. The method of claim 1, wherein the frame buffer value indicates a location on a frame memory where image data of a multi protocol encapsulation (MPE) section included in the transport stream is to be placed, and is obtained by decoding a header of the MPE section.

3. The method of claim 2, wherein the determining of whether the pointer has an error comprises determining whether an error exists in an error indicator included in a header of the transport stream.

4. The method of claim 3, wherein the determining of whether the pointer has an error comprises determining whether an error exists in data of the pointer.

5. The method of claim 4, wherein the determining of whether an error exists in the data of the pointer is made by determining whether a counter has continuity.

6. The method of claim 4, wherein in the determining of whether the pointer has an error, the erroneous pointer is corrected when it is determined that either an error exists in the error indicator or that an error exists in the data of the pointer.

7. The method of claim 6, wherein in the correction of the erroneous pointer, the erroneous pointer is corrected using a header of a transport stream next to the erroneous transport stream.

8. The method of claim 2, wherein the correcting of the frame buffer value comprises:
determining whether a transport stream has been lost;
determining whether the frame buffer value is correct, according to whether the transport stream has been lost; and
correcting and outputting the frame buffer value.

9. The method of claim 8, wherein in determining whether the transport stream has been lost is determined according to continuity or noncontinuity of the counter of the transport stream.

10. The method of claim 2, wherein the correcting of the frame buffer value comprises:
determining whether an error exists in the counter of the transport stream;
determining how much of the transport stream has been lost, when it is determined that an error exists in the counter of the transport stream;
determining whether the frame buffer value is correct, according to how much of the transport stream has been lost; and
correcting and outputting the frame buffer value.

11. The method of claim 10, wherein in determining whether an error exists in the counter of the transport stream, it is determined whether an error exists in the counter when the counter of the current transport stream is inconsecutive to the counter of the previous transport stream.

12. The method of claim 10, wherein the determining of how much of the transport stream has been lost includes considering either the counter values or the existence of the pointer.

13. A method of receiving a digital broadcast comprising:
receiving a radio frequency signal, tuning the received radio frequency signal, transforming the radio frequency signal into a baseband frequency signal, and transmitting the baseband frequency signal;
receiving the baseband frequency signal and restoring the baseband frequency signal to a frequency signal transmitted from a broadcasting station to output a transport stream signal;
determining whether an error exists in a pointer included in the transport stream using a preprocessor, correcting the error, determining whether a frame buffer value is correct, and correcting and outputting the frame buffer value; and
receiving an output signal of the preprocessor and filtering the output signal to output IP data.

14. The method of claim 13, wherein the frame buffer value includes address information indicating a location on a frame memory where image data of an MPE section included in the transport stream is to be placed, and wherein the frame buffer value is obtained by decoding a header of the MPE section.

15. The method of claim 14, wherein the preprocessor determines whether the pointer has an error, by determining whether an error exists in an error indicator included in a header of the transport stream or whether an error exists in the data of the pointer.

16. The method of claim 15, wherein the preprocessor determines whether an error exists in the data of the pointer by determining whether the counter has continuity.

17. The method of claim 13, wherein the preprocessor determines whether a lost transport stream exists, and determines whether the frame buffer value is correct according to the size of the lost transport stream.

18. The method of claim 13, wherein the preprocessor determines whether an error exists in the counter of the transport stream, determines how much of the transport stream has been lost when it is determined that an error exists in the counter of the transport stream, and corrects the frame buffer value according to a result of the determination of how much of the transport stream has been lost.

19. The method of claim 18, wherein the preprocessor determines that an error exists in the counter of the transport stream when the counter of the current transport stream is inconsecutive to the counter of the previous transport stream, and the preprocessor determines the size of the lost transport stream by considering either the counter values or the existence of the pointer.

20. A method of correcting a transport stream, comprising:
transmitting the transport stream from a physical layer;
correcting a pointer included in the transport stream when it is determined that the pointer includes an error; and
correcting a frame buffer value indicating a location of image data included in the transport stream is to be placed when it is determined that the frame buffer value is erroneous.
